(19) United States
(12) Patent Application Publication
(10) Pub. No.: US 2022/0244745 A1
(43) Pub. Date: Aug. 4, 2022

(54) TECHNIQUES FOR EMERGENCY BROADCAST IN AERIAL SYSTEMS

(71) Applicant: QUALCOMM Incorporated, San Diego, CA (US)

(72) Inventors: Harish Singh Bisht, Lalkuan (IN); Rajesh Kotha, Hyderabad (IN); Vishnu Vardhan Reddy Mende, Hyderabad (IN); Sandeep Lnu, Gurgaon (IN)

(21) Appl. No.: 17/162,844

(22) Filed: Jan. 29, 2021

(51) Int. Cl. G05D 1/10; H04W 4/06; H04W 4/90; G08G 5/00; H04W 72/04; G01S 19/42

(52) U.S. Cl. CPC G05D 1/101; H04W 4/06; H04W 4/90; G01S 19/42; H04W 72/042; G08G 5/0056; G08G 5/0039

(57) ABSTRACT

Methods, systems, and devices for wireless communications are described. Generally, the described techniques provide for one or more aerial user equipments (UEs) to receive a broadcast message indicating emergency information via a cellular radio access network (RAN). A base station may receive an indication of emergency information from a third party. The base station may configure a broadcast message including the emergency information. In some examples, the base station may set an emergency protocol notification bit in the broadcast message. The base station may transmit the broadcast message to one or more aerial UEs via a RAN. An aerial UE may receive and decode the broadcast message to obtain emergency instructions. In some examples, the aerial UE may monitor for a system information block (SIB) that may include the emergency instructions. The aerial UE may perform one or more aerial operations based on the emergency instructions.

### FIELD OF TECHNOLOGY

The following relates to wireless communications, including techniques for emergency broadcast in aerial systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

Some wireless communications systems may support one or more aerial user equipments (UEs), which may be devices capable of flying or maneuvering through the air. In case of an emergency, the aerial UEs may cause traffic in the air or otherwise pose a danger to people or objects.

### SUMMARY

The described techniques relate to improved methods, systems, devices, and apparatuses that support techniques for emergency broadcast in aerial systems. Generally, the described techniques provide for a base station to broadcast emergency information to multiple aerial user equipments (UEs) via a radio access network (RAN). In some examples, the aerial UEs may support communications via the RAN (e.g., the aerial UEs may be equipped with RAN equipment). The base station may receive emergency information from a third party, such as a police department, an air traffic controller (ATC), or some other emergency responder. The base station may configure a broadcast message indicating the emergency information and transmit the broadcast message to multiple aerial UEs via the RAN. In some examples, the base station may configure the broadcast message (e.g., a short message) by setting an emergency protocol notification bit in the broadcast message. An aerial UE may receive and decode the broadcast message to obtain the emergency information, corresponding emergency instructions, or both. In some examples, the aerial UE may be configured with emergency instructions, and the aerial UE may perform one or more aerial operations based on the broadcast message and the configured emergency instructions. Additionally or alternatively, an aerial UE may receive the broadcast message and may subsequently monitor for a system information block (SIB) that may include emergency instructions. Multiple aerial UEs may thereby receive emergency information and initiate one or more emergency actions based on a broadcast message received via a RAN.

A method for wireless communications at an aerial UE is described. The method may include receiving, from a base station of a cellular RAN, a broadcast message indicating emergency information, decoding the emergency information to obtain emergency instructions, and performing one or more aerial operations based on the emergency instructions.

An apparatus for wireless communications at an aerial UE is described. The apparatus may include a processor, memory coupled with the processor, and instructions stored in the memory. The instructions may be executable by the processor to cause the apparatus to receive, from a base station of a cellular RAN, a broadcast message indicating emergency information, decode the emergency information to obtain emergency instructions, and perform one or more aerial operations based on the emergency instructions.

Another apparatus for wireless communications at an aerial UE is described. The apparatus may include means for receiving, from a base station of a cellular RAN, a broadcast message indicating emergency information, means for decoding the emergency information to obtain emergency instructions, and means for performing one or more aerial operations based on the emergency instructions.

A non-transitory computer-readable medium storing code for wireless communications at an aerial UE is described. The code may include instructions executable by a processor to receive, from a base station of a cellular RAN, a broadcast message indicating emergency information, decode the emergency information to obtain emergency instructions, and perform one or more aerial operations based on the emergency instructions.

In some examples of the method, apparatuses, and non-transitory computer-readable medium described herein, the emergency information includes an emergency protocol notification bit.

In some examples of the method, apparatuses, and non-transitory computer-readable medium described herein, performing the one or more aerial operations may include operations, features, means, or instructions for performing the one or more aerial operations based on determining that the emergency protocol notification bit may be set.

In some examples of the method, apparatuses, and non-transitory computer-readable medium described herein, the one or more aerial operations may be pre-configured aerial operations.

Some examples of the method, apparatuses, and non-transitory computer-readable medium described herein may further include operations, features, means, or instructions for receiving a subsequent SIB including the emergency instructions.

In some examples of the method, apparatuses, and non-transitory computer-readable medium described herein, performing the one or more aerial operations may include operations, features, means, or instructions for updating one or more target operations of the aerial UE based on the emergency instructions.

In some examples of the method, apparatuses, and non-transitory computer-readable medium described herein, the emergency instructions include safe landing global positioning system (GPS) coordinates, flight path maps for the aerial UE, or both.

In some examples of the method, apparatuses, and non-transitory computer-readable medium described herein, performing the one or more aerial operations may include operations, features, means, or instructions for landing at the safe landing GPS coordinates, updating a flight path of the aerial UE based on the flight path maps, or both based on the emergency instructions.

Some examples of the method, apparatuses, and non-transitory computer-readable medium described herein may further include operations, features, means, or instructions for transmitting the emergency information and the emergency instructions to a controller of the aerial UE.

In some examples of the method, apparatuses, and non-transitory computer-readable medium described herein, the broadcast message may be transmitted to the aerial UE and one or more other aerial UEs via a downlink control channel.

Some examples of the method, apparatuses, and non-transitory computer-readable medium described herein may further include operations, features, means, or instructions for transmitting the broadcast message to one or more other aerial UEs via a sidelink channel.

In some examples of the method, apparatuses, and non-transitory computer-readable medium described herein, the broadcast message may be received from a second aerial UE of the cellular RAN.

A method for wireless communications at a base station is described. The method may include receiving emergency information from a third party, configuring a broadcast message indicating the emergency information, and transmitting, to one or more aerial UEs, the emergency information including an indication of emergency instructions.

An apparatus for wireless communications at a base station is described. The apparatus may include a processor, memory coupled with the processor, and instructions stored in the memory. The instructions may be executable by the processor to cause the apparatus to receive emergency information from a third party, configure a broadcast message indicating the emergency information, and transmit, to one or more aerial UEs, the emergency information including an indication of emergency instructions.

Another apparatus for wireless communications at a base station is described. The apparatus may include means for receiving emergency information from a third party, means for configuring a broadcast message indicating the emergency information, and means for transmitting, to one or more aerial UEs, the emergency information including an indication of emergency instructions.

A non-transitory computer-readable medium storing code for wireless communications at a base station is described. The code may include instructions executable by a processor to receive emergency information from a third party, configure a broadcast message indicating the emergency information, and transmit, to one or more aerial UEs, the emergency information including an indication of emergency instructions.

In some examples of the method, apparatuses, and non-transitory computer-readable medium described herein, the emergency information includes an emergency protocol notification bit and the method, apparatuses, and non-transitory computer-readable medium may include further operations, features, means, or instructions for setting the emergency protocol notification bit based on the emergency information.

In some examples of the method, apparatuses, and non-transitory computer-readable medium described herein, the emergency instructions may be pre-configured emergency instructions at the one or more aerial UEs and the emergency protocol notification bit may indicate that the one or more aerial UEs may perform aerial operations based on the pre-configured emergency instructions.

Some examples of the method, apparatuses, and non-transitory computer-readable medium described herein may further include operations, features, means, or instructions for transmitting, to the one or more aerial UEs, a SIB including the emergency instructions.

In some examples of the method, apparatuses, and non-transitory computer-readable medium described herein, the emergency instructions include new safe landing GPS coordinates, updated flight path maps for the one or more aerial UEs, other emergency instructions, or a combination thereof.

In some examples of the method, apparatuses, and non-transitory computer-readable medium described herein, the third party may be an emergency responder, an aerial traffic control, an unmanned traffic management (UTM), or a combination thereof.

In some examples of the method, apparatuses, and non-transitory computer-readable medium described herein, the emergency information indicates an area in which an emergency occurs.

In some examples of the method, apparatuses, and non-transitory computer-readable medium described herein, the broadcast message may be broadcast to the one or more aerial UEs in the area in which the emergency occurs.

In some examples of the method, apparatuses, and non-transitory computer-readable medium described herein, the broadcast message includes the emergency information and other system information for the one or more aerial UEs.

In some examples of the method, apparatuses, and non-transitory computer-readable medium described herein, the base station may be a radio access node on an aerial UE.

### BRIEF DESCRIPTION OF THE DRAWINGS

FIG. 1 illustrates an example of a wireless communications system that supports techniques for emergency broadcast in aerial systems in accordance with aspects of the present disclosure.

FIG. 2 illustrates an example of a wireless communications system that supports techniques for emergency broadcast in aerial systems in accordance with aspects of the present disclosure.

FIG. 3 illustrates an example of a process flow that supports techniques for emergency broadcast in aerial systems in accordance with aspects of the present disclosure.

FIG. 4 illustrates an example of a process flow that supports techniques for emergency broadcast in aerial systems in accordance with aspects of the present disclosure.

FIGS. 5 and 6 show block diagrams of devices that support techniques for emergency broadcast in aerial systems in accordance with aspects of the present disclosure.

FIG. 7 shows a block diagram of a communications manager that supports techniques for emergency broadcast in aerial systems in accordance with aspects of the present disclosure.

FIG. 8 shows a diagram of a system including a device that supports techniques for emergency broadcast in aerial systems in accordance with aspects of the present disclosure.

FIGS. 9 and 10 show block diagrams of devices that support techniques for emergency broadcast in aerial systems in accordance with aspects of the present disclosure.

FIG. 11 shows a block diagram of a communications manager that supports techniques for emergency broadcast in aerial systems in accordance with aspects of the present disclosure.

FIG. 12 shows a diagram of a system including a device that supports techniques for emergency broadcast in aerial systems in accordance with aspects of the present disclosure.

FIGS. 13 through 17 show flowcharts illustrating methods that support techniques for emergency broadcast in aerial systems in accordance with aspects of the present disclosure.

### DETAILED DESCRIPTION

Some wireless communications systems may support aerial user equipments (UEs) which may be devices capable of flying or maneuvering through the air. One example of an aerial UE is an unmanned aerial vehicle (UAV), which may also be referred to as a drone. In some examples, the aerial UEs may communicate with aerial UE controllers, which may be referred to as UAV controllers (UAVCs), that may control the aerial UEs (e.g., using internet, Bluetooth, or any form of radio frequency communications). Additionally or alternatively, the aerial UEs may be configured with radio access network (RAN) equipment and may communicate with base stations or other network entities via the RAN (e.g., using 3rd Generation Partnership Project (3GPP) technologies, such as New Radio (NR) networks). In some emergency scenarios (e.g., earthquakes, tsunamis, or other emergencies in which free air space may be desired), emergency responders such as the police, the air traffic control (ATC), or the unmanned traffic management (UTM), may be unable to efficiently broadcast emergency information to multiple aerial UEs in the surrounding area.

As described herein, a third party (e.g., an emergency responder) may transmit a broadcast message including emergency information to one or more aerial UEs via a cellular RAN using a message (e.g., a broadcast short message). In some systems (e.g., NR networks), a short message may be used to transmit information, page wireless devices, or both, on a physical downlink control channel (PDCCH). Each short message may include a number of bits (e.g., eight bits, or some other number of bits). Some of the bits in the short message may be configured to transmit system information, and the remaining bits in the short message may be unused or ignored. One or more bits in the short message may be designated (e.g., configured) as an emergency protocol notification bit for emergency scenarios.

When a base station, or other network entity, receives emergency information from a third party, the base station may configure an emergency broadcast message by setting the emergency protocol notification bit in a short message. For example, setting the emergency protocol notification bit may include changing the bit value (e.g., from a zero to a one). The base station may broadcast the short message to one or more aerial UEs via the RAN. Multiple aerial UEs in the vicinity of the emergency scenario may receive the short message and decode the message to determine if the emergency protocol notification bit is set. In one example, an aerial UE may be configured with emergency aerial operations. If the emergency protocol notification bit is set, the aerial UE will initiate the configured emergency aerial operations. In another example, an aerial UE may receive the short message indicating the emergency scenario, and the aerial UE may subsequently receive a system information block (SIB) or some other subsequent message defined for aerial UE emergency protocol. The aerial UE may decode the SIB or other message to obtain emergency instructions. The emergency instructions, the configured emergency aerial operations, or both, may include safe landing coordinates, updated flight paths, or other emergency operations for the aerial UE.

Aspects of the disclosure are initially described in the context of wireless communications systems. Examples of processes and signaling exchanges that support emergency broadcast in aerial systems are then described. Aspects of the disclosure are further illustrated by and described with reference to apparatus diagrams, system diagrams, and flowcharts that relate to techniques for emergency broadcast in aerial systems.

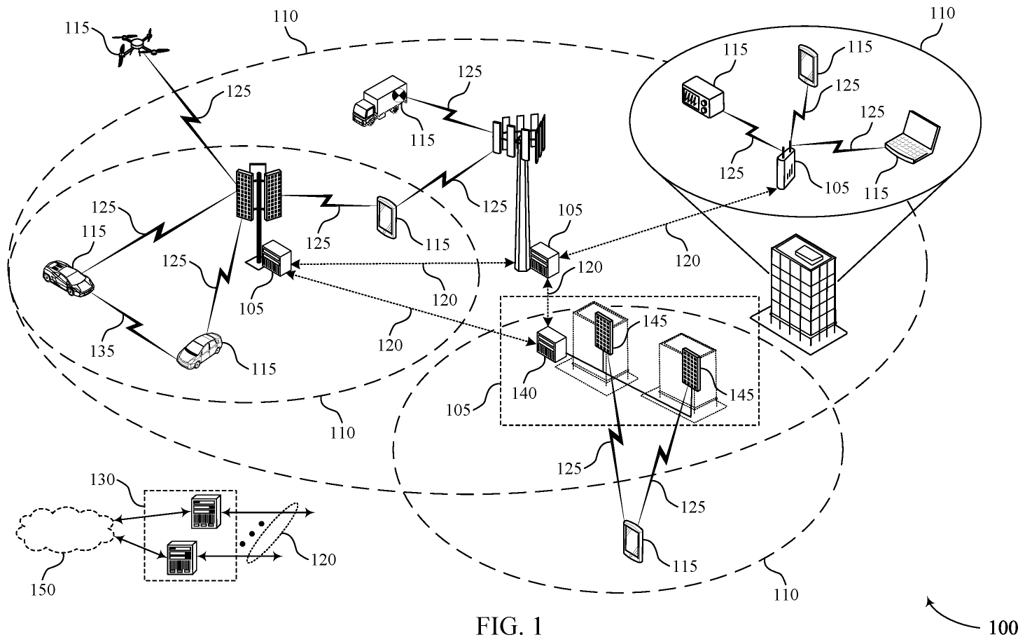

FIG. 1 illustrates an example of a wireless communications system 100 that supports techniques for emergency broadcast in aerial systems in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a NR network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support one or more aerial UEs 115, which may capable of flying or maneuvering through the air. In some examples, an aerial UE 115 may communicate with a base station 105 via a communication link 125. In an emergency scenario, a base station 105 may receive emergency information from an emergency responder (e.g., the police, the ATC, or some other third party). The base station 105 may configure a broadcast message to convey the emergency information to one or more aerial UEs 115 in the surrounding area. For example, the base station 105 may configure a short message to indicate the emergency. The aerial UEs 115 may receive the broadcast emergency message and may decode the message to obtain emergency instructions. In some examples, the base station 105 may subsequently transmit a SIB containing emergency instructions for the aerial UEs 115. Additionally or alternatively, the aerial UEs 115 may be configured (e.g., pre-configured) with emergency instructions. The aerial UEs 115 may perform emergency aerial operations based on the emergency instructions.

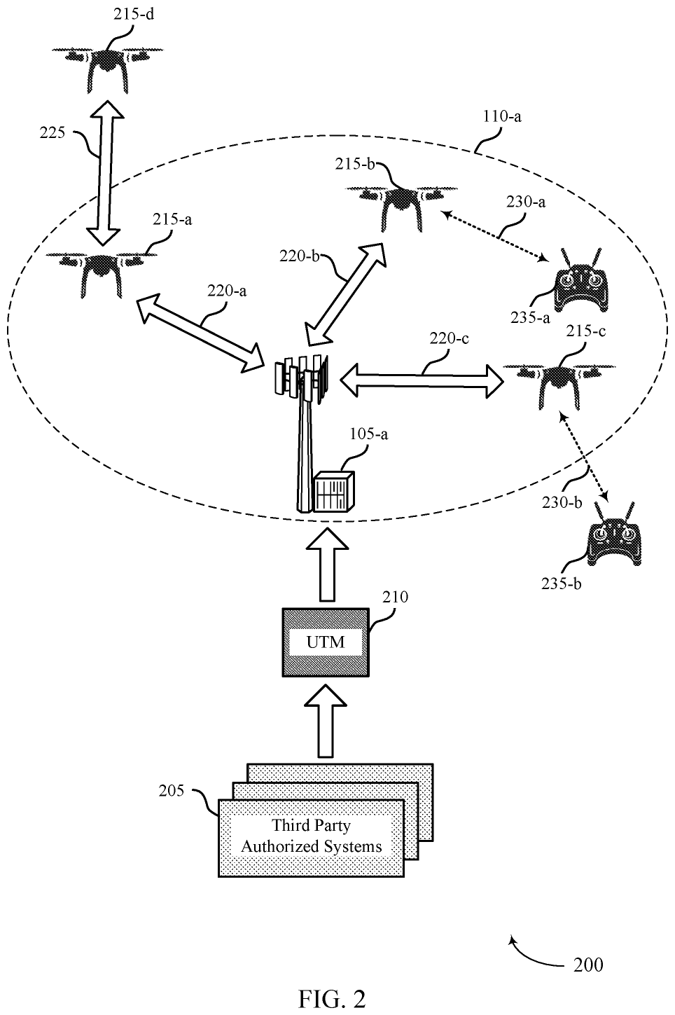

FIG. 2 illustrates an example of a wireless communications system 200 that supports techniques for emergency broadcast in aerial systems in accordance with aspects of the present disclosure. The wireless communications system 200 may include a base station 105-a, and one or more aerial UEs 215, which may be examples of a base station 105 and an aerial UE 115 as described with reference to FIG. 1. Base station 105-a may communicate with the aerial UEs 215 (e.g., aerial UEs 215-a, 215-b, and 215-c) within a geographic coverage area 110-a. During an emergency scenario, base station 105-a may broadcast an emergency message to one or more of the aerial UEs 215.

An aerial UE 215 may establish a connection 220 (e.g., Uu connectivity) with a base station 105-a (e.g., a cell), and the aerial UE 215 may communicate with base station 105-a to support different applications (e.g., video, remote command and control (C2), etc.). For example, aerial UEs 215-a, 215-b, and 215-c may establish connections 220-a, 220-b, and 220-c, respectively, with base station 105-a. An aerial UE 215 may additionally or alternatively establish a connection 225 (e.g., a PC5) with another aerial UE 215 and may communicate with the other aerial UE 215 to support other applications (e.g., user-to-everything (U2X) detect and avoid (D2X-DAA) applications and other applications mainly used for collision control). For example, aerial UE 215-a may establish the connection 225 with aerial UE 215-d (e.g., a remote aerial UE 215-d) and/or connection 220-a with base station 105-a.

In some examples, an aerial UE 215 may additionally or alternatively establish a connection 230 (e.g., using internet, Bluetooth, or any form of radio frequency communication) with an aerial UE controller 235 (e.g., a remote control). In some cases, the connection 230 may be within visual line of sight, while in other cases the connection 230 may be beyond visual line of sight (e.g., up to 10 km or beyond). The connection 230 may be referred to as a U2X-C2 connection and may be, for example, a PC5, bidirectional connection. For example, aerial UE 215-b may establish connection 230-a with aerial UE controller 235-a, and aerial UE 215-c may establish connection 230-b with aerial UE controller 235-b.

Each aerial UE 215 may identify or receive flight information from a respective aerial UE controller 235, from base station 105-a, from another aerial UE 215 that may be configured as a base station 105 (e.g., a radio access node on-board an aerial UE (UxNB)), or a combination thereof. In some examples, the flight information may be generated by an UTM 210, and the UTM 210 may transmit the information to base station 105-a, the aerial UE controller 235, or the UxNB to forward to the aerial UE 215.

In some cases, an aerial UE 215 may receive flight information and other control signaling from a respective aerial UE controller 235, and the aerial UE 215 may not support wireless communications via a RAN. Such an aerial UE 215 may be referred to as a standalone aerial UE 215. The aerial UE controller 235 may be connected with a base station 105 (e.g., via a RAN), with the UTM 210, or the aerial UE controller 235 may communicate with the aerial UE 215 outside the scope of the RAN (e.g., using internet, Bluetooth, or the like). In some examples, the aerial UE 215, the aerial UE controller 235, or both, may support wireless communications via select service providers.

In the example of the wireless communications system 200, the aerial UEs 215-a 215-b and 215-c may support similar operations to non-aerial UEs 115 when connected to a wireless network. For instance, the aerial UEs 215 may be configured with RAN equipment such that the aerial UEs 215 may enable 3GPP technologies (e.g., NR) In some examples, an aerial UE 215 may support some communications via a wireless network and other communications and applications via a connection 230 with an aerial UE controller 235. For example, aerial UE 215-c may receive communications from base station 105-a via connection 220-c and from aerial UE controller 235-c via connection 230-b.

In some cases, during an emergency scenario, each aerial UE controller 235 may communicate a notification of the emergency, emergency instructions, or both, to a respective aerial UE 215 (e.g., via unicast transmission) based on an emergency notification from the UTM 210. The multiple unicast transmissions by each aerial UE controller 235 may result in significant overhead and latency. As such, it may be desirable to notify multiple aerial UEs 215 of an emergency scenario via the wireless network (e.g., using a broadcast message).

In some cases (e.g., in cellular emergency services), base station 105-a may be operable to broadcast an emergency notification to multiple non-aerial UEs 115 (e.g., phones, IoT devices, or other devices not pictured in FIG. 2). For example, base station 105-a (e.g., or some other network entity) may support a public warning system (PWS), and base station 105-a may transmit an earthquake and tsunami warning system (ETWS) message, an Amber Alert message, or other commercial mobile alert system (CMAS) messages to multiple devices. The PWS messages may be broadcast via a short message (e.g., an eight bit broadcast message), which may be configured to transmit system information, page the UEs 115, or both. The short message may be broadcast via a PDCCH using a paging radio network temporary identifier (P-RNTI) over downlink control information (DCI) (e.g., a Short Message field in DCI format 1_0). The short message may be transmitted with or without an associated paging message that may include additional information for the receiving UEs 115. Some of the bits in the short message may be configured (e.g., pre-configured and/or defined in a standard) for indicating system information or a respective emergency notification. Remaining bits in the short message may be unused or ignored.

As described herein, one or more bits in the short message may be configured as emergency protocol notification bits for notifying aerial UEs 215 of an emergency (e.g., during emergencies in which clear air space, or other actions by the aerial UEs 215 may be desired). An example configuration for the short message including an emergency protocol notification bit is shown in Table 1. Aerial UEs 215-a, 215-b, and 215-c (e.g., and one or more other aerial UEs 215 that are equipped with RAN equipment) may monitor the wireless network for a broadcast short message from base station 105-a. Base station 105-a may thereby broadcast the short message via the wireless network to notify multiple aerial UEs 215 of the emergency with less overhead and latency than if each aerial UE controller 235 transmits the notification to a respective aerial UE 215.

TABLE 1
Short Message Configuration

| Bit | Short Message |
|---|---|
| 1 | systemInfoModification |
| | If set to 1: indication of a broadcast control channel (BCCH) |
| | modification other than SIB6, SIB7 and SIB 8. |
| 2 | etwsAndCmasIndication |
| | If set to 1: indication of an ETWS |
| | primary notification and/or an ETWS |
| | secondary notification and/or a CMAS notification. |
| 3 | stopPagingMonitoring |
| | If set to 1: a UE 115 or an aerial UE 215 may |
| | stop monitoring PDCCH occasion(s) for paging |
| 4-7 | Not used in current releases, and may be ignored by a UE 115 |
| | (e.g., or an aerial UE 215) if received. |
| 8 | Emergency Protocol Notification Bit |
| | If set to 1: indication of an aerial UE 215 |
| | emergency protocol initiation and/or notification. |

Table 1 illustrates an example bit configuration for a short message (e.g., a short message that may include eight bits). Although not depicted in Table 1, the short message may include any number of bits, and the emergency protocol notification bit may be configured as one bit, two bits, or some other number of bits within the short message. In some examples, the emergency protocol notification bit may be configured as any bit in the short message. For example, any of bits 1-8 in Table 1 may be configured (e.g., or re-configured) as the emergency protocol notification bit, or any other bit in a short message that includes a different number of bits may be configured as the emergency protocol notification bit. In some examples, one or more other bits in the short message may be configured to convey other system information for the aerial UEs 215 (e.g., other emergency information).

The receiving UEs 115 and aerial UEs 215 may decode the short message to identify which bit(s) of the short message are set (e.g., to 1) and which bits of the short message are not set (e.g., 0). Depending on which bit is set, the UEs 115 and aerial UEs 215 may determine to perform an action or to ignore the short message. For example, in the example short message configuration depicted in Table 1, if bit 8 is set, one or more non-aerial UEs 115 may ignore the short message, and one or more aerial UEs 215 that receive the short message may perform emergency action, monitor for additional system information in a second message (e.g., in a body of a SIB) following the short message, or both.

An emergency may be identified by one or more third party authorized systems 205 (e.g., air traffic control (ATC), police departments, or the like). The UTM 210 may receive an indication of the emergency from the third party authorized systems 205. The UTM 210 may initiate an emergency notification for the aerial UEs 215 by forwarding the indication of the emergency and/or emergency instructions to base station 105-a (e.g., to be transmitted to the aerial UEs 215 via a cellular network). Base station 105-a may configure a short message and may broadcast the short message to aerial UEs 215-a, 215-b, 215-c, and one or more other aerial UEs 215 in a surrounding area (e.g., within geographic coverage area 110-a, or within some other physical area). Base station 105-a may configure the short message to indicate the emergency by enabling the emergency protocol notification bit (e.g., setting a pre-determined bit in the short message to ‘1’).

In some examples, aerial UEs 215-a, 215-b, and 215-c may be configured (e.g., pre-configured during a configuration by an aerial UE controller 235 or a base station 105) with an emergency action configuration. For example, the aerial UEs 215 may be configured with emergency instructions indicating one or more aerial operations that the aerial UEs 215 may perform during an emergency. In such cases, aerial UEs 215-a, 215-b, and 215-c may be referred to as autonomous aerial UEs 215 (e.g., capable of performing one or more aerial operations without signaling from a controller). The configured emergency instructions may include safe landing global positioning system (GPS) coordinates, flight path maps for the aerial UEs 215, other emergency instructions, or a combination thereof. An aerial UE 215 that receives the short message, decodes the short message, and identifies that the emergency protocol notification bit is set may perform the configured emergency action(s) accordingly. For example, an aerial UE 215 may safely land at a pre-determined safe landing location, maneuver to a pre-determined altitude, leave a configured physical area, follow an indicated flight path, or the like.

Additionally or alternatively, aerial UEs 215-a, 215-b, and 215-c (e.g., emergency action capable aerial UEs 215) may receive and decode the short message to identify whether the emergency protocol notification bit is set. If the emergency protocol bit is set, the aerial UEs 215 may monitor for another message including emergency instructions from base station 105-a. The message may be a SIB that may be configured for conveying emergency instructions for aerial UEs 215. The SIB may include safe landing GPS coordinates, emergency vector coordinates, updated flight paths, other emergency instructions, or a combination thereof for the aerial UEs 215. Each aerial UE 215 may decode the SIB, obtain the emergency instructions, and perform one or more emergency aerial operations based on the emergency instructions.

To perform the emergency aerial operations (e.g., the pre-configured operations or the operations indicated via a SIB), an aerial UE 215 may update one or more target operations of the aerial UE 215. For example, the aerial UE 215 may update a current flight path map, change target GPS coordinates for the aerial UE 215 to the safe landing GPS coordinates, or the like.

The aerial UE controllers 235 may or may not receive (e.g., or monitor for) the broadcast short message from base station 105-a. For example, aerial UE controller 235-b may be a remote aerial UE controller 235-b (e.g., located outside of geographic coverage area 110-a or a cell associated with base station 105-a) and may not receive communications from base station 105-a (e.g., aerial UE controller 235-b may not be connected via the RAN). Aerial UE controller 235-a may not monitor for communications from base station 105-a via the RAN, or may not be configured to receive and/or identify the short message including the aerial UE 215 emergency protocol notification bit. As such, the aerial UE controllers 235 may not obtain a notification of the emergency, the emergency instructions, the updated operations for the aerial UEs 215, or a combination thereof.

In some examples, aerial UEs 215-b and 215-c may forward the emergency notification and instructions (e.g., an emergency command) to aerial UE controllers 235-a and 235-b, respectively, to indicate the emergency protocol and updated emergency actions. Aerial UEs 215-b and 215-c may forward the emergency notification and instructions via connections 230-a and 230-b, respectively. Additionally or alternatively, aerial UEs 215-b and 215-c may transmit an indication to base station 105-a, and base station 105-a may transmit an emergency indication to the aerial UE controllers 235 (e.g., via the RAN).

One or more remote aerial UEs 215, such as aerial UE 215-d, may be located outside of geographic coverage area 110-a (e.g., a remote aerial UE 215-d) and may not receive the emergency notification or emergency instructions from base station 105-a. Aerial UE 215-a may forward the emergency notification to remote aerial UE 215-d via sidelink connection 225 (e.g., via an aerial UE 215 sidelink channel). In some examples, aerial UE 215-a may forward the short message to multiple neighboring aerial UEs 215 by broadcasting the short message (e.g., using the aerial UE 215 sidelink channel).

Accordingly, aerial UEs 215 may be configured to monitor a downlink control channel within a RAN for a broadcast short message. The aerial UEs 215 may identify whether a configured emergency protocol notification bit in the short message is set to determine whether to perform emergency operations, monitor for a subsequent SIB containing emergency instructions, or both. By receiving the emergency information via the RAN, the aerial UEs 215 may support reduced latency and overhead associated with emergency notification operations.

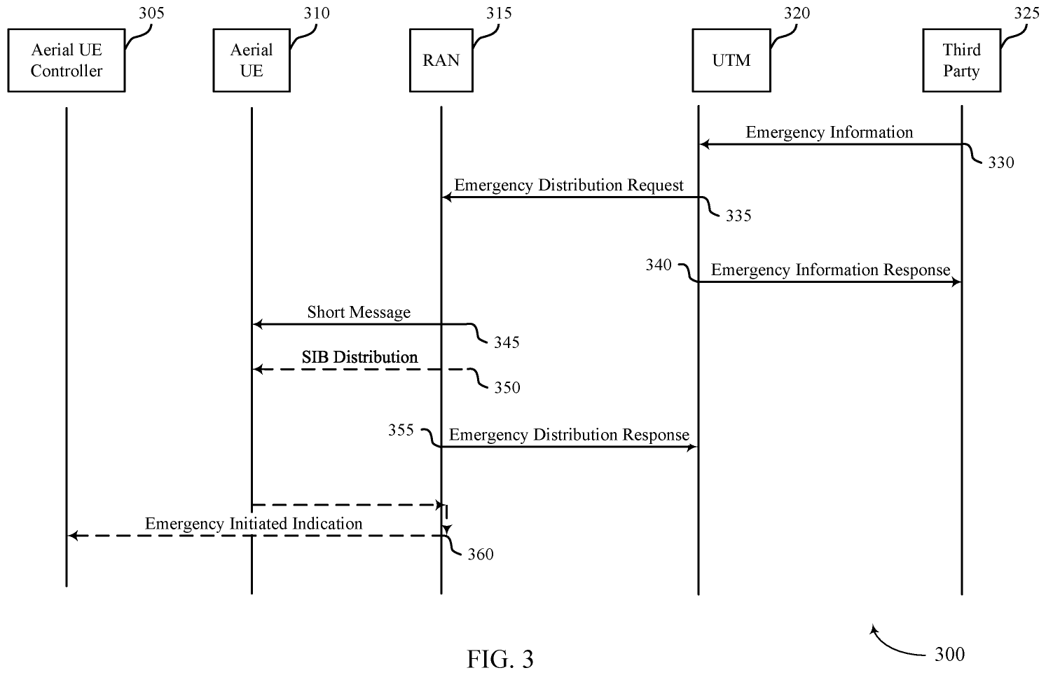

FIG. 3 illustrates an example of a process flow 300 that supports techniques for emergency broadcast in aerial systems in accordance with aspects of the present disclosure. In some examples, the process flow 300 may implement various aspects of the present disclosure described with reference to FIGS. 1 and 2. For example, the process flow 300 may illustrate a procedure for initializing an emergency notification and broadcasting an emergency message to aerial UEs 310 via a RAN 315. The process flow 300 may include an aerial UE 310 and an aerial UE controller 305, which may be examples of an aerial UE 215 and an aerial UE controller 235 as described with reference to FIG. 2. The process flow 300 may include a third party 325 and a UTM 320, which may be examples of the third party authorized systems 205 and the UTM 210, as described with reference to FIG. 2. In some examples, the RAN 315 may broadcast an emergency message to the aerial UE 310. The RAN 315 may be an example of a wireless network that includes a transmitting network entity, such as base station 105-a as described with reference to FIG. 2.

It is understood that the devices and nodes described by the process flow 300 may communicate with or be coupled with other devices or nodes that are not illustrated. For instance, the aerial UE controller 305, the aerial UE 310, the RAN 315, or a combination thereof, may communicate with one or more other aerial UE controllers 305, aerial UEs 310, base stations 105, or other devices. Alternative examples of the following may be implemented, where some steps are performed in a different order than described or are not performed at all. In some cases, a step may include additional features not mentioned below, or further steps may be added.

At 330, the third party 325 (e.g., ATC, a police department, an emergency responder, or the like) may transmit emergency information to the UTM 320. The emergency information may include an indication of an emergency scenario, a relevant area (e.g., a geographic area that may be affected by the emergency), a request for clear air space in the area (e.g., all air space in an indicated area, air space above a certain elevation, or the like), a request for identification of each aerial UE 310 in the area (e.g., an identification of registered and unregistered aerial UEs 310), or a combination thereof.

At 335, the UTM 320 may initialize an emergency notification by transmitting an emergency distribution request to the RAN 315. The emergency distribution request may include the emergency instructions provided by the third party 325. The emergency distribution request may request that the emergency instructions be broadcast to multiple aerial UEs 310 in an indicated area via the RAN.

At 340, the UTM 320 may transmit an emergency information response to the third party 325. The emergency information response may indicate receipt of the emergency information (e.g., an acknowledgement of the emergency information). Additionally or alternatively, the emergency information response may indicate that the UTM 320 forwarded the emergency information to the RAN 315.

At 345, the RAN 315 may transmit a message (e.g., a short message) to the aerial UE 310. A network entity within the RAN 315 may configure the short message to indicate the emergency scenario by setting an emergency protocol notification bit (e.g., a configured bit) in the short message to high (e.g., by changing a value of the bit), as described with reference to FIG. 2 and Table 1. The network entity may broadcast the short message to the aerial UE 310 and one or more other aerial UEs 310 in a surrounding area via the RAN 315 (e.g., in the area indicated by the third party 325 in the emergency information). The short message may be transmitted via a PDCCH using a P-RNTI.

In some examples, the network entity may be a base station 105, as described with reference to FIG. 2. Additionally or alternatively, an aerial UE 310 configured as a base station 105 may broadcast the short message to the aerial UE 310 and one or more other aerial UEs 310 via the RAN 315. For example, an aerial UE 310 may be equipped with base station 105 facility, such that the aerial UE 310 may become an UxNB. The UxNB may connect to the RAN 315 (e.g., a core network) and may perform network operations as a base station 105 via wireless links (e.g., the UxNB may bootstrap as a base station 105 from the core network perspective for broadcasting system information). The UxNB may be authorized by the RAN 315 (e.g., a 5G system) before the UxNB may broadcast.

At 350, in some examples, the RAN 315 (e.g., a base station 105 or UxNB associated with the RAN 315) may perform SIB distribution. The RAN 315 may transmit a SIB to the aerial UE 310 and one or more other aerial UEs 310. The SIB may include emergency instructions for the aerial UEs 310. In some examples, the SIB may broadcast to each aerial UE 310 in a surrounding area. Additionally or alternatively, multiple SIBs may be transmitted, and each SIB may contain different emergency information and/or instructions for each respective aerial UE 310. If the aerial UEs 310 are configured (e.g., pre-configured) with emergency instructions (e.g., autonomous aerial UEs 310), the RAN 315 may transmit the SIB to convey additional emergency instructions. In some examples, the RAN 315 may not transmit the SIB.

At 355, the RAN 315 may transmit an emergency distribution response to the UTM 320. The emergency distribution response may acknowledge receipt of the emergency distribution request from the UTM 320 and may indicate that the RAN 315 has distributed the emergency information.

At 360, in some examples, the aerial UE 310 may forward the emergency instructions to an aerial UE controller 305. The aerial UE controller 305 may not receive the short message indicating the emergency scenario and/or the SIB conveying the emergency instructions (e.g., the aerial UE controller 305 may not be autonomous). As such, the aerial UE 310 may transmit an indication (e.g., an emergency command) to the aerial UE controller 305 to inform the aerial UE controller 305 of the emergency protocol and updated emergency aerial operations that the aerial UE 310 may perform. In some examples, the aerial UE 310 may forward the emergency instructions to the aerial UE controller 305 via the RAN 315. For example, the aerial UE 310 may transmit an indication that the corresponding aerial UE controller 305 did not receive the emergency instructions, and the RAN may transmit an emergency initiated indication to the aerial UE controller 305 accordingly. Additionally or alternatively, the aerial UE 310 may forward the emergency information directly to the aerial UE controller.

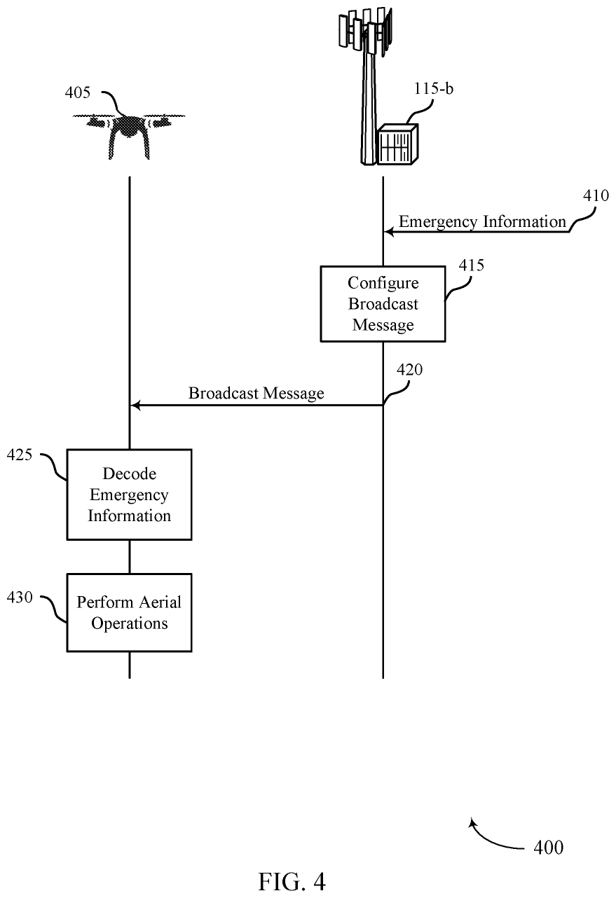

FIG. 4 illustrates an example of a process flow 400 that supports techniques for emergency broadcast in aerial systems in accordance with aspects of the present disclosure. In some examples, the process flow 400 may implement various aspects of the present disclosure described with reference to FIGS. 1 through 3. The process flow 400 may include aerial UE 405 and base station 105-b, which may be examples of aerial UEs and base stations as described with reference to FIGS. 1 through 3. In some examples, base station 105-b may broadcast an emergency message to the aerial UE 405 and one or more other aerial UEs 405 via a wireless network.

It is understood that the devices and nodes described by the process flow 400 may communicate with or be coupled with other devices or nodes that are not illustrated. For instance, the aerial UE 405, base station 105-b, or both, may communicate with one or more other aerial UEs 405, base stations 105, or other devices. Alternative examples of the following may be implemented, where some steps are performed in a different order than described or are not performed at all. In some cases, a step may include additional features not mentioned below, or further steps may be added.

At 410, base station 105-b may receive emergency information from a third party.

At 415, base station 105-b may configure a broadcast message indicating the emergency information. The broadcast message may be an example of a short message as described with reference to FIGS. 2 and 3. In some examples, configuring the broadcast message may include setting an emergency protocol notification bit in the broadcast short message.

At 420, base station 105-b may transmit the broadcast message indicating the emergency information to the aerial UE 405 and one or more other aerial UEs 405 (e.g., via a wireless cellular network).

At 425, the aerial UE 405 may decode the emergency information to obtain emergency instructions. In some examples, the aerial UE 405 may decode the emergency protocol notification bit in the broadcast message, and the aerial UE 405 may monitor for a subsequent system information message (e.g., a SIB) from base station 105-b that may include the emergency instructions.

At 430, the aerial UE 405 may perform one or more aerial operations based on the emergency instructions. In some examples, the aerial operations may be configured at the aerial UE 405, and the aerial UE 405 may perform the aerial operations based on identifying the emergency protocol notification bit in the broadcast message. Additionally or alternatively, the aerial UE 405 may perform the aerial operations based on the emergency instructions received via the SIB.

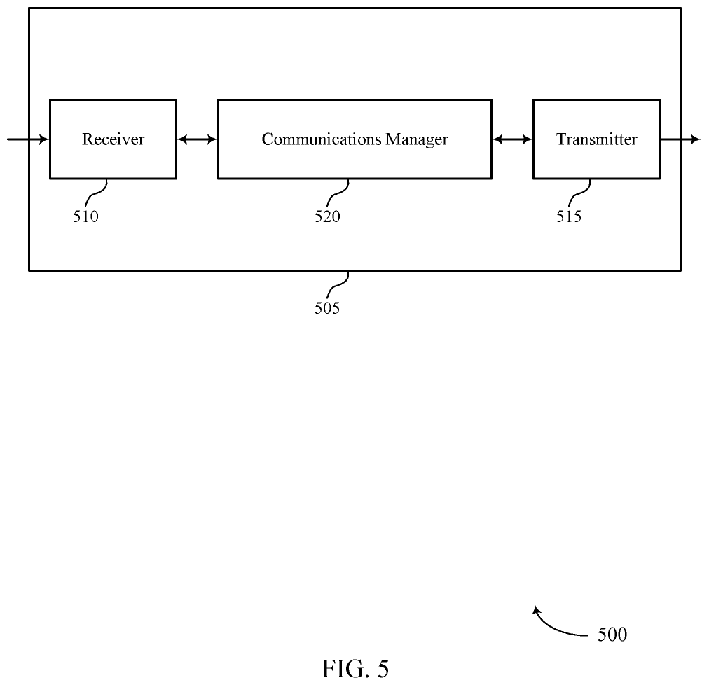

FIG. 5 shows a block diagram 500 of a device 505 that supports techniques for emergency broadcast in aerial systems in accordance with aspects of the present disclosure. The device 505 may be an example of aspects of a UE 115 (e.g., an aerial UE) as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for emergency broadcast in aerial systems). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for emergency broadcast in aerial systems). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for emergency broadcast in aerial systems as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at an aerial UE in accordance with examples as disclosed herein. For example, the communications manager 520 may be configured as or otherwise support a means for receiving, from a base station of a cellular RAN, a broadcast message indicating emergency information. The communications manager 520 may be configured as or otherwise support a means for decoding the emergency information to obtain emergency instructions. The communications manager 520 may be configured as or otherwise support a means for performing one or more aerial operations based on the emergency instructions.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing and more efficient utilization of communication resources. For example, the device 505 (e.g., an aerial UE) may decode an emergency protocol notification bit in a broadcast message to obtain instructions for emergency aerial operations. By identifying whether the emergency protocol notification bit (e.g., a pre-configured bit in a short message) is set or not, a processor of the device 505 may refrain from monitoring for and/or decoding unnecessary system information, which may reduce processing. In some examples, the device 505 may be configured with one or more emergency aerial operations. By performing the configured emergency aerial operations based on the emergency protocol notification bit, the processor of the device 505 may refrain from decoding other instructions, which may provide for reduced processing and more efficient utilization of communication resources.

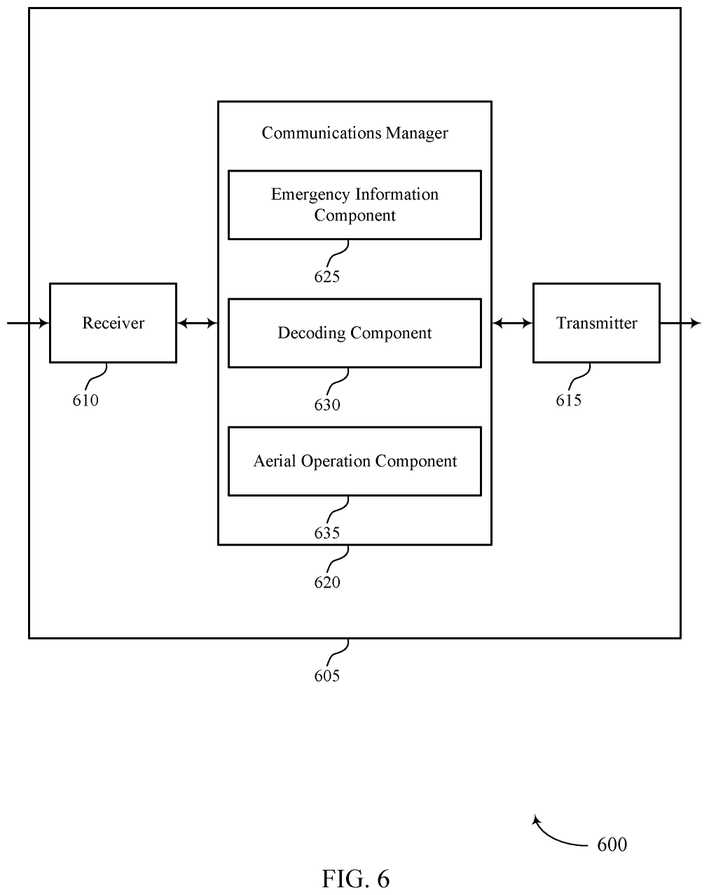

FIG. 6 shows a block diagram 600 of a device 605 that supports techniques for emergency broadcast in aerial systems in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for emergency broadcast in aerial systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for emergency broadcast in aerial systems). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for emergency broadcast in aerial systems as described herein. For example, the communications manager 620 may include an emergency information component 625, a decoding component 630, an aerial operation component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at an aerial UE in accordance with examples as disclosed herein. The emergency information component 625 may be configured as or otherwise support a means for receiving, from a base station of a cellular RAN, a broadcast message indicating emergency information. The decoding component 630 may be configured as or otherwise support a means for decoding the emergency information to obtain emergency instructions. The aerial operation component 635 may be configured as or otherwise support a means for performing one or more aerial operations based on the emergency instructions.

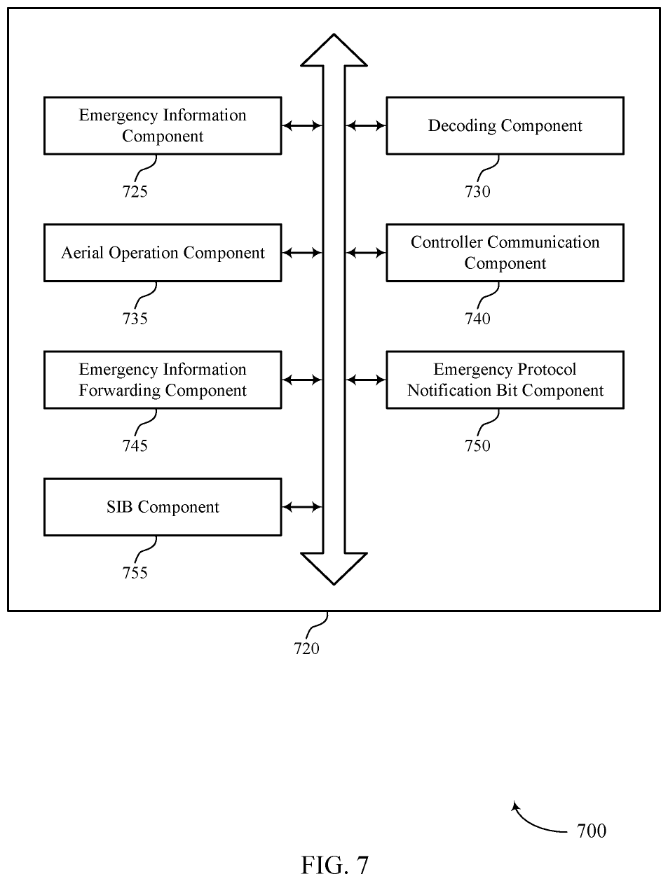

FIG. 7 shows a block diagram 700 of a communications manager 720 that supports techniques for emergency broadcast in aerial systems in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for emergency broadcast in aerial systems as described herein. For example, the communications manager 720 may include an emergency information component 725, a decoding component 730, an aerial operation component 735, a controller communication component 740, an emergency information forwarding component 745, an emergency protocol notification bit component 750, an SIB component 755, or any combination thereof. Each of these components may communicate, directly or indirectly, with one another (e.g., via one or more buses).

The communications manager 720 may support wireless communications at an aerial UE in accordance with examples as disclosed herein. The emergency information component 725 may be configured as or otherwise support a means for receiving, from a base station of a cellular RAN, a broadcast message indicating emergency information. The decoding component 730 may be configured as or otherwise support a means for decoding the emergency information to obtain emergency instructions. The aerial operation component 735 may be configured as or otherwise support a means for performing one or more aerial operations based on the emergency instructions.

In some examples, the emergency information may include an emergency protocol notification bit. In some examples, to support performing the one or more aerial operations, the emergency protocol notification bit component 750 may be configured as or otherwise support a means for performing the one or more aerial operations based on determining that the emergency protocol notification bit is set. In some examples, the one or more aerial operations may be pre-configured aerial operations.

In some examples, the SIB component 755 may be configured as or otherwise support a means for receiving a subsequent SIB including the emergency instructions.

In some examples, to support performing the one or more aerial operations, the aerial operation component 735 may be configured as or otherwise support a means for updating one or more target operations of the aerial UE based on the emergency instructions.

In some examples, the emergency instructions include safe landing GPS coordinates, flight path maps for the aerial UE, or both.

In some examples, to support performing the one or more aerial operations, the aerial operation component 735 may be configured as or otherwise support a means for landing at the safe landing GPS coordinates, updating a flight path of the aerial UE based on the flight path maps, or both based on the emergency instructions.

In some examples, the controller communication component 740 may be configured as or otherwise support a means for transmitting the emergency information and the emergency instructions to a controller of the aerial UE. In some examples, the emergency information forwarding component 745 may be configured as or otherwise support a means for transmitting the broadcast message to one or more other aerial UEs via a sidelink channel. In some examples, the broadcast message is received from a second aerial UE of the cellular RAN.

In some examples, the broadcast message is transmitted to the aerial UE and one or more other aerial UEs via a downlink control channel.

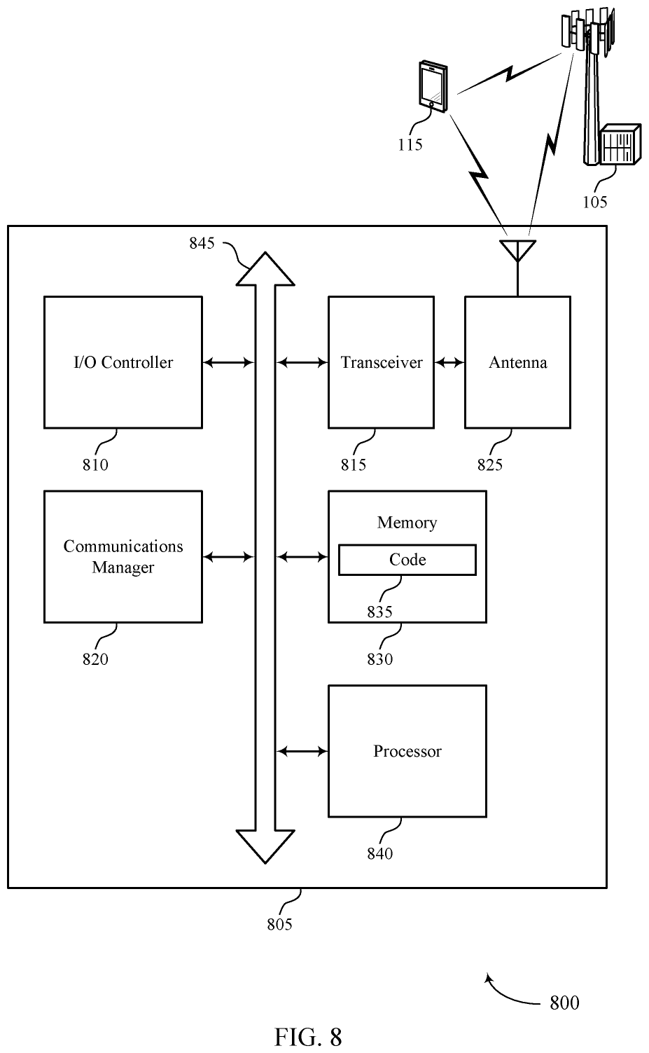

FIG. 8 shows a diagram of a system 800 including a device 805 that supports techniques for emergency broadcast in aerial systems in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for emergency broadcast in aerial systems). For example, the device 805 or a component of the device 805 may include a processor 840 and memory 830 coupled to the processor 840, the processor 840 and memory 830 configured to perform various functions described herein.

The communications manager 820 may support wireless communications at an aerial UE in accordance with examples as disclosed herein. For example, the communications manager 820 may be configured as or otherwise support a means for receiving, from a base station of a cellular RAN, a broadcast message indicating emergency information. The communications manager 820 may be configured as or otherwise support a means for decoding the emergency information to obtain emergency instructions. The communications manager 820 may be configured as or otherwise support a means for performing one or more aerial operations based on the emergency instructions.

By including or configuring the communications manager 820 in accordance with examples as described herein, the device 805 may support techniques for reduced latency, more efficient utilization of communication resources, and improved coordination between devices. For example, the device 805 (e.g., an aerial UE) may be configured to identify whether an emergency protocol notification bit is set in a broadcast short message transmitted to the device 805 and one or more other devices 805, which may use fewer communication resources and result in less latency than if each device 805 receives individual unicast transmissions from respective controllers. Additionally or alternatively, the device 805 may receive similar emergency instructions as one or more other neighboring devices at a similar time, which may provide for improved coordination between the devices 805 when performing emergency aerial operations.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for emergency broadcast in aerial systems as described herein, or the processor 840 and the memory 830 may be otherwise configured to perform or support such operations.

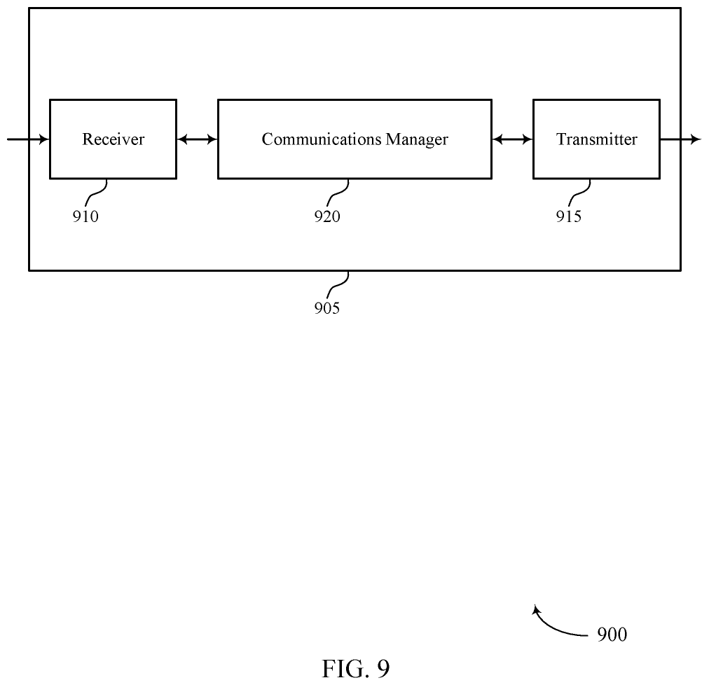

FIG. 9 shows a block diagram 900 of a device 905 that supports techniques for emergency broadcast in aerial systems in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for emergency broadcast in aerial systems). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for emergency broadcast in aerial systems). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for emergency broadcast in aerial systems as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for receiving emergency information from a third party. The communications manager 920 may be configured as or otherwise support a means for configuring a broadcast message indicating the emergency information. The communications manager 920 may be configured as or otherwise support a means for transmitting, to one or more aerial UEs, the emergency information including an indication of emergency instructions.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced processing and more efficient utilization of communication resources. For example, the processor of the device 905 (e.g., a base station 105) may configure a broadcast message that may convey an emergency notification to multiple aerial UEs, which may provide for reduced processing and more efficient utilization of communication resources (e.g., compared to multiple unicast transmissions indicating the emergency). In some examples, the processor may set a bit in the broadcast message to convey the emergency indication, and the processor may set one or more other bits in the broadcast message to convey additional system information, which may provide for reduced processing and more efficient utilization of communication resources.

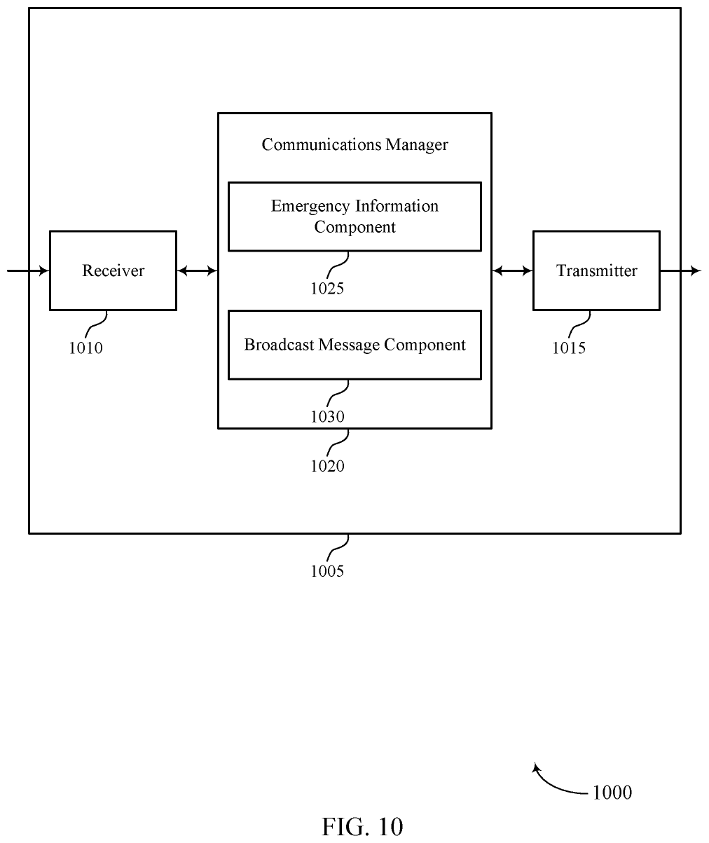

FIG. 10 shows a block diagram 1000 of a device 1005 that supports techniques for emergency broadcast in aerial systems in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for emergency broadcast in aerial systems). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for emergency broadcast in aerial systems). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for emergency broadcast in aerial systems as described herein. For example, the communications manager 1020 may include an emergency information component 1025 a broadcast message component 1030, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The emergency information component 1025 may be configured as or otherwise support a means for receiving emergency information from a third party. The broadcast message component 1030 may be configured as or otherwise support a means for configuring a broadcast message indicating the emergency information. The emergency information component 1025 may be configured as or otherwise support a means for transmitting, to one or more aerial UEs, the emergency information including an indication of emergency instructions.

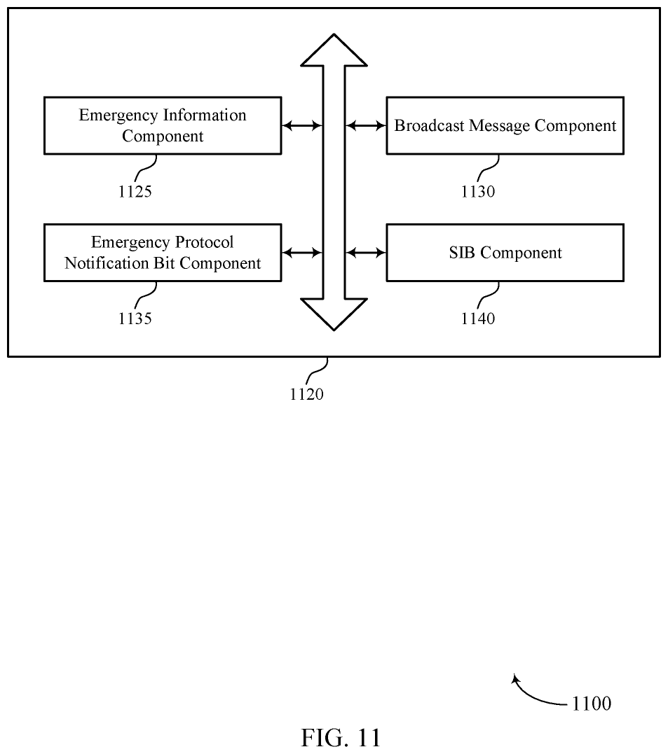

FIG. 11 shows a block diagram 1100 of a communications manager 1120 that supports techniques for emergency broadcast in aerial systems in accordance with aspects of the present disclosure. The communications manager 1120 may be an example of aspects of a communications manager 920, a communications manager 1020, or both, as described herein. The communications manager 1120, or various components thereof, may be an example of means for performing various aspects of techniques for emergency broadcast in aerial systems as described herein. For example, the communications manager 1120 may include an emergency information component 1125, a broadcast message component 1130, an emergency protocol notification bit component 1135, an SIB component 1140, or any combination thereof. Each of these components may communicate, directly or indirectly, with one another (e.g., via one or more buses).

The communications manager 1120 may support wireless communications at a base station in accordance with examples as disclosed herein. The emergency information component 1125 may be configured as or otherwise support a means for receiving emergency information from a third party. The broadcast message component 1130 may be configured as or otherwise support a means for configuring a broadcast message indicating the emergency information. In some examples, the emergency information component 1125 may be configured as or otherwise support a means for transmitting, to one or more aerial UEs, the emergency information including an indication of emergency instructions.

In some examples, the emergency information includes an emergency protocol notification bit, and the emergency protocol notification bit component 1135 may be configured as or otherwise support a means for setting the emergency protocol notification bit based on the emergency information. In some examples, the emergency instructions may be pre-configured emergency instructions at the one or more aerial UEs and the emergency protocol notification bit may indicate that the one or more aerial UEs are to perform aerial operations based on the pre-configured emergency instructions.

In some examples, the SIB component 1140 may be configured as or otherwise support a means for transmitting, to the one or more aerial UEs, a SIB including the emergency instructions.

In some examples, the emergency instructions include new safe landing GPS coordinates, updated flight path maps for the one or more aerial UEs, other emergency instructions, or a combination thereof.

In some examples, the third party may be an emergency responder, an ATC, an UTM, or a combination thereof. In some examples, the emergency information indicates an area in which an emergency occurs. In some examples, the broadcast message is broadcast to the one or more aerial UEs in the area in which the emergency occurs.

In some examples, the broadcast message includes the emergency information and other system information for the one or more aerial UEs.

In some examples, the base station is a radio access node on an aerial UE.

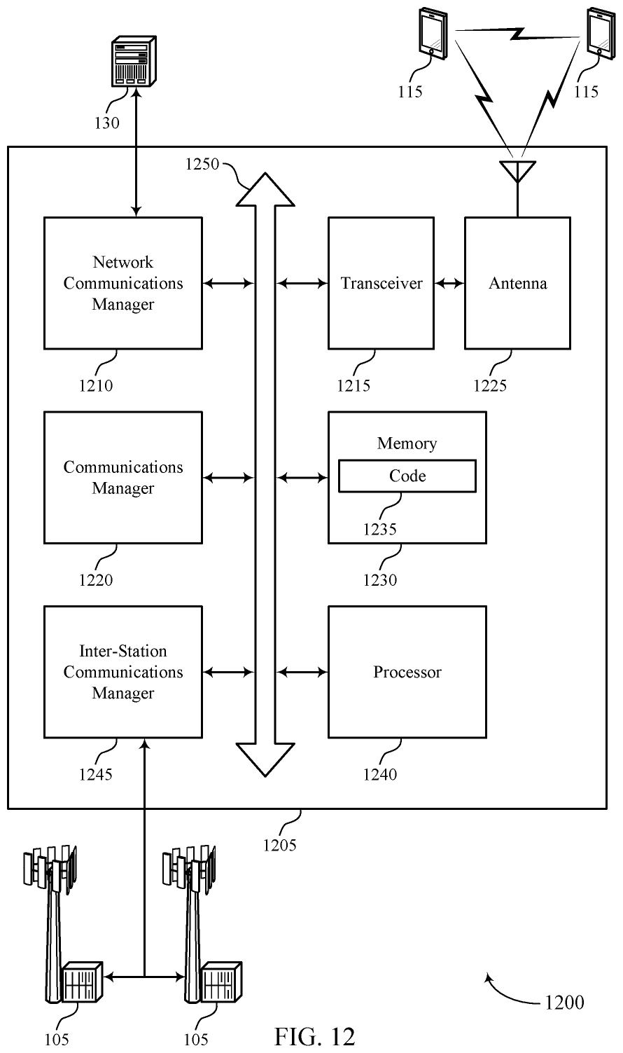

FIG. 12 shows a diagram of a system 1200 including a device 1205 that supports techniques for emergency broadcast in aerial systems in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for emergency broadcast in aerial systems). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for receiving emergency information from a third party. The communications manager 1220 may be configured as or otherwise support a means for configuring a broadcast message indicating the emergency information. The communications manager 1220 may be configured as or otherwise support a means for transmitting, to one or more aerial UEs, the emergency information including an indication of emergency instructions.

By including or configuring the communications manager 1220 in accordance with examples as described herein, the device 1205 may support techniques for reduced latency, more efficient utilization of communication resources, and improved coordination between devices. For example, the device 1205 (e.g., a base station 105) may notify multiple aerial UEs of an emergency scenario concurrently via a broadcast message, which may provide for reduced latency (e.g., less latency than individual transmissions to each aerial UE). Additionally or alternatively, by transmitting the emergency notification, emergency instructions, or both, to the multiple aerial UEs via the broadcast message, the device 1205 may improve coordination between devices in a wireless network (e.g., instead of multiple aerial UE controllers transmitting emergency instructions to each aerial UE). In some examples, the device 1205 may transmit an emergency notification, one or more other system information notifications, or both, in the broadcast message (e.g., a short message), which may provide for more efficient utilization of communication resources.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for emergency broadcast in aerial systems as described herein, or the processor 1240 and the memory 1230 may be otherwise configured to perform or support such operations.

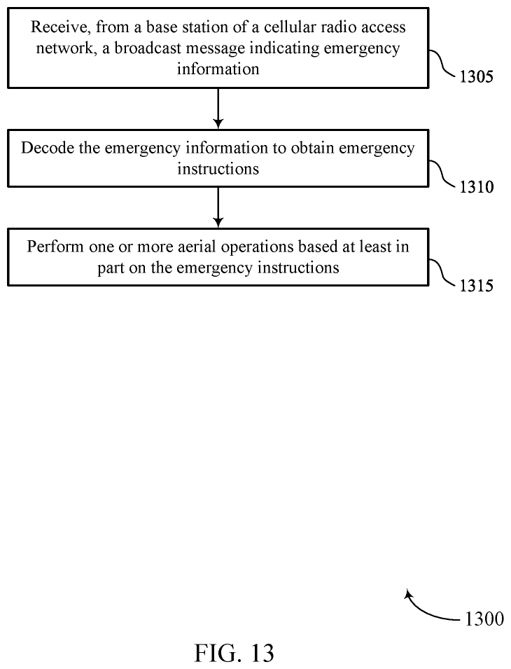

FIG. 13 shows a flowchart illustrating a method 1300 that supports techniques for emergency broadcast in aerial systems in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station of a cellular RAN, a broadcast message indicating emergency information. The operations of 1305 may be performed in accordance with examples as disclosed herein. In some examples, aspects of the operations of 1305 may be performed by an emergency information component 725 as described with reference to FIG. 7.

At 1310, the method may include decoding the emergency information to obtain emergency instructions. The operations of 1310 may be performed in accordance with examples as disclosed herein. In some examples, aspects of the operations of 1310 may be performed by a decoding component 730 as described with reference to FIG. 7.

At 1315, the method may include performing one or more aerial operations based on the emergency instructions. The operations of 1315 may be performed in accordance with examples as disclosed herein. In some examples, aspects of the operations of 1315 may be performed by an aerial operation component 735 as described with reference to FIG. 7.

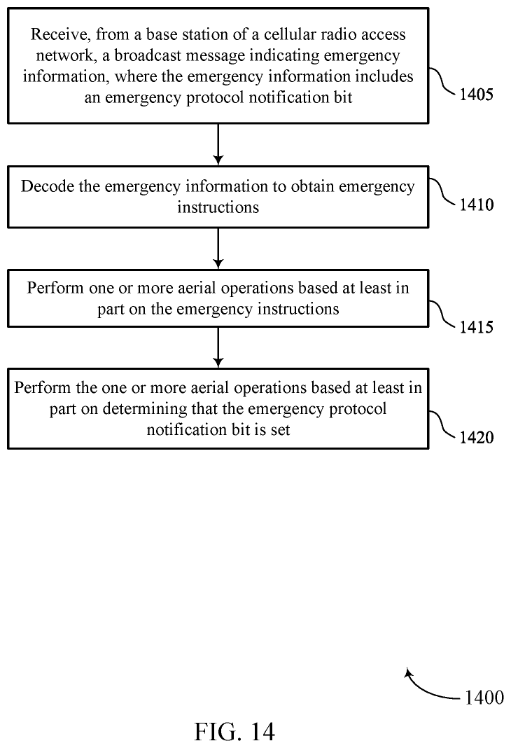

FIG. 14 shows a flowchart illustrating a method 1400 that supports techniques for emergency broadcast in aerial systems in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station of a cellular RAN, a broadcast message indicating emergency information. In some examples, the emergency information may include an emergency protocol notification bit. The operations of 1405 may be performed in accordance with examples as disclosed herein. In some examples, aspects of the operations of 1405 may be performed by an emergency information component 725 as described with reference to FIG. 7.

At 1410, the method may include decoding the emergency information to obtain emergency instructions. The operations of 1410 may be performed in accordance with examples as disclosed herein. In some examples, aspects of the operations of 1410 may be performed by a decoding component 730 as described with reference to FIG. 7.

At 1415, the method may include performing one or more aerial operations based on the emergency instructions. The operations of 1415 may be performed in accordance with examples as disclosed herein. In some examples, aspects of the operations of 1415 may be performed by an aerial operation component 735 as described with reference to FIG. 7.

At 1420, the method may include performing the one or more aerial operations based on determining that the emergency protocol notification bit is set. The operations of 1420 may be performed in accordance with examples as disclosed herein. In some examples, aspects of the operations of 1420 may be performed by an emergency protocol notification bit component 750 as described with reference to FIG. 7.

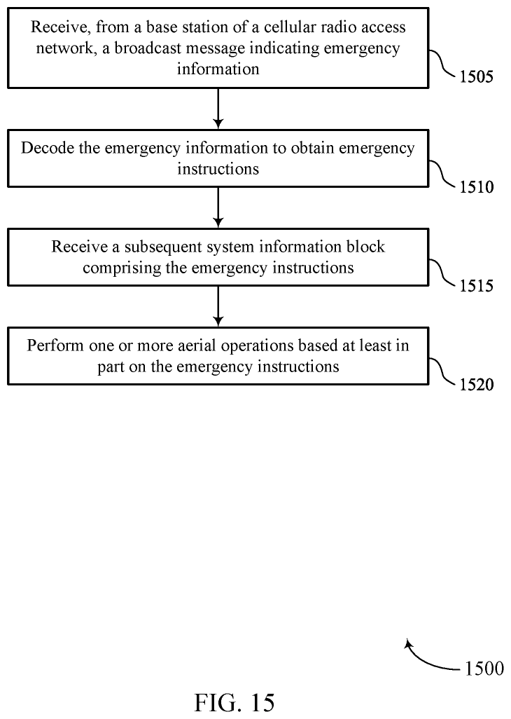

FIG. 15 shows a flowchart illustrating a method 1500 that supports techniques for emergency broadcast in aerial systems in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving, from a base station of a cellular RAN, a broadcast message indicating emergency information. The operations of 1505 may be performed in accordance with examples as disclosed herein. In some examples, aspects of the operations of 1505 may be performed by an emergency information component 725 as described with reference to FIG. 7.

At 1510, the method may include decoding the emergency information to obtain emergency instructions. The operations of 1510 may be performed in accordance with examples as disclosed herein. In some examples, aspects of the operations of 1510 may be performed by a decoding component 730 as described with reference to FIG. 7.

At 1515, the method may include receiving a subsequent SIB including the emergency instructions. The operations of 1515 may be performed in accordance with examples as disclosed herein. In some examples, aspects of the operations of 1515 may be performed by an SIB component 755 as described with reference to FIG. 7.

At 1520, the method may include performing one or more aerial operations based on the emergency instructions. The operations of 1520 may be performed in accordance with examples as disclosed herein. In some examples, aspects of the operations of 1520 may be performed by an aerial operation component 735 as described with reference to FIG. 7.

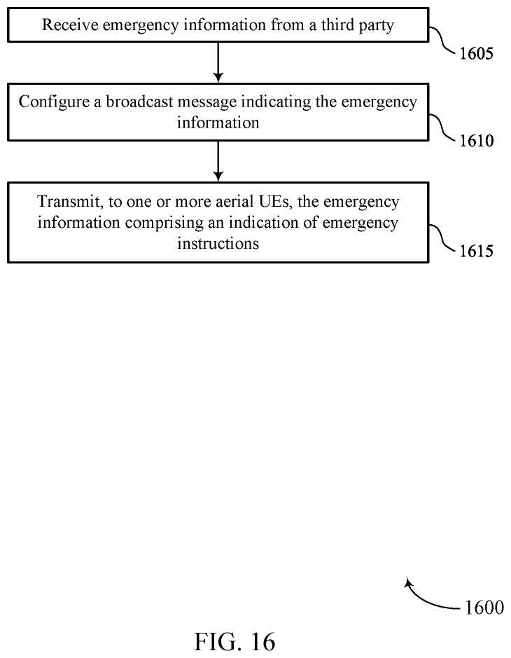

FIG. 16 shows a flowchart illustrating a method 1600 that supports techniques for emergency broadcast in aerial systems in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include receiving emergency information from a third party. The operations of 1605 may be performed in accordance with examples as disclosed herein. In some examples, aspects of the operations of 1605 may be performed by an emergency information component 1125 as described with reference to FIG. 11.

At 1610, the method may include configuring a broadcast message indicating the emergency information. The operations of 1610 may be performed in accordance with examples as disclosed herein. In some examples, aspects of the operations of 1610 may be performed by a broadcast message component 1130 as described with reference to FIG. 11.

At 1615, the method may include transmitting, to one or more aerial UEs, the emergency information including an indication of emergency instructions. The operations of 1615 may be performed in accordance with examples as disclosed herein. In some examples, aspects of the operations of 1615 may be performed by an emergency information component 1125 as described with reference to FIG. 11.

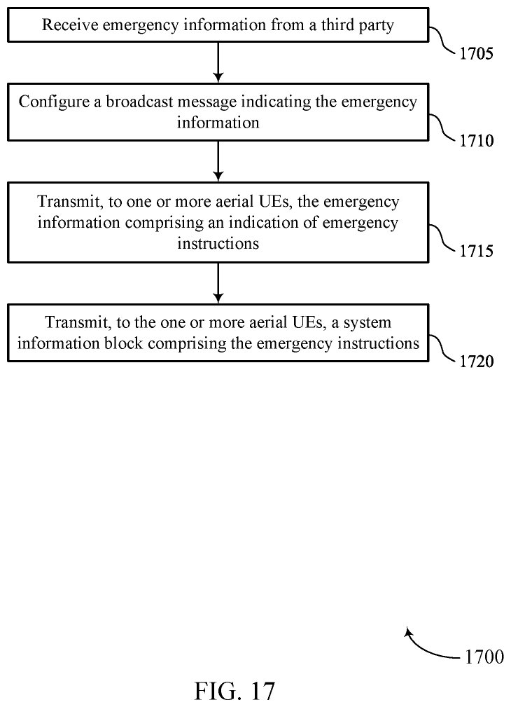

FIG. 17 shows a flowchart illustrating a method 1700 that supports techniques for emergency broadcast in aerial systems in accordance with aspects of the present disclosure. The operations of the method 1700 may be implemented by a base station or its components as described herein. For example, the operations of the method 1700 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1705, the method may include receiving emergency information from a third party. The operations of 1705 may be performed in accordance with examples as disclosed herein. In some examples, aspects of the operations of 1705 may be performed by an emergency information component 1125 as described with reference to FIG. 11.

At 1710, the method may include configuring a broadcast message indicating the emergency information. The operations of 1710 may be performed in accordance with examples as disclosed herein. In some examples, aspects of the operations of 1710 may be performed by a broadcast message component 1130 as described with reference to FIG. 11.

At 1715, the method may include transmitting, to one or more aerial UEs, the emergency information including an indication of emergency instructions. The operations of 1715 may be performed in accordance with examples as disclosed herein. In some examples, aspects of the operations of 1715 may be performed by an emergency information component 1125 as described with reference to FIG. 11.

At 1720, the method may include transmitting, to the one or more aerial UEs, a SIB including the emergency instructions. The operations of 1720 may be performed in accordance with examples as disclosed herein. In some examples, aspects of the operations of 1720 may be performed by an SIB component 1140 as described with reference to FIG. 11.

### Summary of Aspects

The following provides an overview of aspects of the present disclosure:

Aspect 1: A method for wireless communications at an aerial user equipment (UE), comprising: receiving, from a base station of a cellular radio access network (RAN), a broadcast message indicating emergency information; decoding the emergency information to obtain emergency instructions; and performing one or more aerial operations based at least in part on the emergency instructions.

Aspect 2: The method of aspect 1, wherein the emergency information comprises an emergency protocol notification bit.

Aspect 3: The method of aspect 2, wherein performing the one or more aerial operations comprises: performing the one or more aerial operations based at least in part on determining that the emergency protocol notification bit is set.

Aspect 4: The method of aspect 3, wherein the one or more aerial operations are pre-configured aerial operations.

Aspect 5: The method of any of aspects 2 through 3, further comprising: receiving a subsequent system information block (SIB) comprising the emergency instructions.

Aspect 6: The method of any of aspects 1 through 5, wherein performing the one or more aerial operations further comprises: updating one or more target operations of the aerial UE based at least in part on the emergency instructions.

Aspect 7: The method of any of aspects 1 through 6, wherein the emergency instructions comprise safe landing global positioning system (GPS) coordinates, flight path maps for the aerial UE, or both.

Aspect 8: The method of aspect 7, wherein performing the one or more aerial operations comprises: landing at the safe landing GPS coordinates, updating a flight path of the aerial UE based at least in part on the flight path maps, or both based at least in part on the emergency instructions.

Aspect 9: The method of any of aspects 1 through 8, further comprising: transmitting the emergency information and the emergency instructions to a controller of the aerial UE.

Aspect 10: The method of any of aspects 1 through 9, wherein the broadcast message is transmitted to the aerial UE and one or more other aerial UEs via a downlink control channel.

Aspect 11: The method of any of aspects 1 through 10, further comprising: transmitting the broadcast message to one or more other aerial UEs via a sidelink channel.

Aspect 12: The method of any of aspects 1 through 11, wherein the broadcast message is received from a second aerial UE of the cellular RAN.

Aspect 13: A method for wireless communications at a base station, comprising: receiving emergency information from a third party; configuring a broadcast message indicating the emergency information; and transmitting, to one or more aerial UEs, the emergency information comprising an indication of emergency instructions.

Aspect 14: The method of aspect 13, wherein the emergency information comprises an emergency protocol notification bit, the method further comprising: setting the emergency protocol notification bit based at least in part on the emergency information.

Aspect 15: The method of aspect 14, wherein the emergency instructions are pre-configured emergency instructions at the one or more aerial UEs and the emergency protocol notification bit indicates that the one or more aerial UEs are to perform aerial operations based at least in part on the pre-configured emergency instructions.

Aspect 16: The method of any of aspects 13 through 1415, further comprising: transmitting, to the one or more aerial UEs, a SIB comprising the emergency instructions.

Aspect 17: The method of any of aspects 13 through 16, wherein the emergency instructions comprise new safe landing GPS coordinates, updated flight path maps for the one or more aerial UEs, other emergency instructions, or a combination thereof.

Aspect 18: The method of any of aspects 13 through 17, wherein the third party is an emergency responder, an aerial traffic control, an UTM, or a combination thereof.

Aspect 19: The method of any of aspects 13 through 18, wherein the emergency information indicates an area in which an emergency occurs.

Aspect 20: The method of aspect 19, wherein the broadcast message is broadcast to the one or more aerial UEs in the area in which the emergency occurs.

Aspect 21: The method of any of aspects 13 through 20, wherein the broadcast message comprises the emergency information and other system information for the one or more aerial UEs.

Aspect 22: The method of any of aspects 13 through 21, wherein the base station is a radio access node on an aerial UE.

Aspect 23: An apparatus for wireless communications at an aerial UE, comprising a processor; memory coupled with the processor; and instructions stored in the memory and executable by the processor to cause the apparatus to perform a method of any of aspects 1 through 12.

Aspect 24: An apparatus for wireless communications at an aerial UE, comprising at least one means for performing a method of any of aspects 1 through 12.

Aspect 25: A non-transitory computer-readable medium storing code for wireless communications at an aerial UE, the code comprising instructions executable by a processor to perform a method of any of aspects 1 through 12.

Aspect 26: An apparatus for wireless communications at a base station, comprising a processor; memory coupled with the processor; and instructions stored in the memory and executable by the processor to cause the apparatus to perform a method of any of aspects 13 through 22.

Aspect 27: An apparatus for wireless communications at a base station, comprising at least one means for performing a method of any of aspects 13 through 22.

Aspect 28: A non-transitory computer-readable medium storing code for wireless communications at a base station, the code comprising instructions executable by a processor to perform a method of any of aspects 13 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at an aerial user equipment (UE), comprising:
receiving, from a base station of a cellular radio access network, a broadcast message indicating emergency information;
decoding the emergency information to obtain emergency instructions; and
performing one or more aerial operations based at least in part on the emergency instructions.

2. The method of claim 1, wherein the emergency information comprises an emergency protocol notification bit.

3. The method of claim 2, wherein performing the one or more aerial operations comprises:
performing the one or more aerial operations based at least in part on determining that the emergency protocol notification bit is set.

4. The method of claim 3, wherein the one or more aerial operations are pre-configured aerial operations.

5. The method of claim 2, further comprising:
receiving a subsequent system information block comprising the emergency instructions.

6. The method of claim 1, wherein performing the one or more aerial operations further comprises:
updating one or more target operations of the aerial UE based at least in part on the emergency instructions.

7. The method of claim 1, wherein the emergency instructions comprise safe landing global positioning system coordinates, flight path maps for the aerial UE, or both.

8. The method of claim 7, wherein performing the one or more aerial operations comprises:
landing at the safe landing global positioning system coordinates, updating a flight path of the aerial UE based at least in part on the flight path maps, or both based at least in part on the emergency instructions.

9. The method of claim 1, further comprising:
transmitting the emergency information and the emergency instructions to a controller of the aerial UE.

10. The method of claim 1, wherein the broadcast message is transmitted to the aerial UE and one or more other aerial UEs via a downlink control channel.

11. The method of claim 1, further comprising:
transmitting the broadcast message to one or more other aerial UEs via a sidelink channel.

12. The method of claim 1, wherein the broadcast message is received from a second aerial UE of the cellular radio access network.

13. A method for wireless communications at a base station, comprising:
receiving emergency information from a third party;
configuring a broadcast message indicating the emergency information; and
transmitting, to one or more aerial user equipments (UEs), the emergency information comprising an indication of emergency instructions.

14. The method of claim 13, wherein the emergency information comprises an emergency protocol notification bit, the method further comprising:
setting the emergency protocol notification bit based at least in part on the emergency information.

15. The method of claim 14, wherein the emergency instructions are pre-configured emergency instructions at the one or more aerial UEs and the emergency protocol notification bit indicates that the one or more aerial UEs are to perform aerial operations based at least in part on the pre-configured emergency instructions.

16. The method of claim 13, further comprising:
transmitting, to the one or more aerial UEs, a system information block comprising the emergency instructions.

17. The method of claim 13, wherein the emergency instructions comprise new safe landing global positioning system coordinates, updated flight path maps for the one or more aerial UEs, other emergency instructions, or a combination thereof.

18. The method of claim 13, wherein the third party is an emergency responder, an aerial traffic control, an unmanned traffic management, or a combination thereof.

19. The method of claim 13, wherein the emergency information indicates an area in which an emergency occurs.

20. The method of claim 19, wherein the broadcast message is broadcast to the one or more aerial UEs in the area in which the emergency occurs.

21. The method of claim 13, wherein the broadcast message comprises the emergency information and other system information for the one or more aerial UEs.

22. The method of claim 13, wherein the base station is a radio access node on an aerial UE.

23. An apparatus for wireless communications at an aerial user equipment (UE), comprising:
a processor;
memory coupled with the processor; and
instructions stored in the memory and executable by the processor to cause the apparatus to:
receive, from a base station of a cellular radio access network, a broadcast message indicating emergency information;
decode the emergency information to obtain emergency instructions; and
perform one or more aerial operations based at least in part on the emergency instructions.

24. The apparatus of claim 23, wherein the emergency information comprises an emergency protocol notification bit.

25. The apparatus of claim 24, wherein the instructions to perform the one or more aerial operations are executable by the processor to cause the apparatus to:
perform the one or more aerial operations based at least in part on determining that the emergency protocol notification bit is set.

26. The apparatus of claim 25, wherein the one or more aerial operations are pre-configured aerial operations.

27. The apparatus of claim 24, wherein the instructions are further executable by the processor to cause the apparatus to:
receive a subsequent system information block comprising the emergency instructions.

28. An apparatus for wireless communications at a base station, comprising:
a processor;
memory coupled with the processor; and
instructions stored in the memory and executable by the processor to cause the apparatus to:
receive emergency information from a third party;
configure a broadcast message indicating the emergency information; and
transmit, to one or more aerial user equipments (UEs), the emergency information comprising an indication of emergency instructions.

29. The apparatus of claim 28, wherein the emergency information comprises an emergency protocol notification bit, and the instructions are further executable by the processor to cause the apparatus to:
set the emergency protocol notification bit based at least in part on the emergency information.

30. The apparatus of claim 28, wherein the instructions are further executable by the processor to cause the apparatus to:
transmit, to the one or more aerial UEs, a system information block comprising the emergency instructions.
